(19) United States
(12) Patent Application Publication
(10) Pub. No.: US 2008/0154918 A1
(43) Pub. Date: Jun. 26, 2008

(54) Database Schemer Update Method

(75) Inventors: Takeshi Iwatsu, Kanagawa (JP); Noriyuki Sakoh, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corporation, Tokyo (JP)

(21) Appl. No.: 10/567,776

(22) PCT Filed: Jul. 6, 2004
(86) PCT No.: PCT/JP2004/009891

§ 371 Date: Feb. 9, 2006

(30) Foreign Application Priority Data
Sep. 24, 2003 (JP) 2003-332565

(51) Int. Cl. G06F 7/00; G06F 17/30

(52) U.S. Cl. 707/100; 707/E17.005

(57) ABSTRACT

In this invention, a client terminal CT receives programs of the latest version and a schema-change instruction file SF from an update-information providing server 3. After the programs are updated in terms of version, the indicator information SD of the schema-change instruction file SF is compared with the indicator information log SDL described in a schema-change log file SL, thereby determining the version of the present schema. If the schema needs to be updated, it is automatically updated in accordance with the schema-change instruction file SF. Thus, the database schema is automatically updated to be of the latest version at all times.

### TECHNICAL FIELD

The present invention relates to a method of updating a database schema. The method is suitable for use in updating the database schema that is incorporated in, for example, a communication terminal.

### BACKGROUND ART

Hitherto, to update a database schema in order to add tables, columns and the like that can store new data, a manager assigned to the database first stops the entire system utilizing the database and then switches the system to the backup system.

In recent years, databases are provided not only in servers, but also in various communication terminals such as notebook personal computers, PDAs (Personal Digital Assistants). To update the database schemas incorporated in any communication terminal, the user of the terminal need to perform manual operations.

In view of this, a method has been proposed. In the method, a database schema is supplied, if necessary, via a network to a communication terminal, and the communication terminal automatically switch the database schema to the new one. (See, for example, Patent Document 1.)

Patent Document 1: Jpn. Pat. Appln. Publication 2000-268054.

In this method, however, tables, columns or the like cannot be added if the existing database keeps holding the data it has stored. After all, the user must manually update the existing database schema.

If the user forgets to update the database schema, the data added to the information supplied to the communication terminal via the network, which should be reflected in new tables or new columns, cannot be reflected in the tables or columns existing in the database.

### DISCLOSURE OF THE INVENTION

The present invention has been made in view of the foregoing. An object of the invention is to provide a method of updating a database schema, which can automatically update the database schema, always to the database schema of the latest version.

To achieve this object, a method of updating a database schema, according to the present invention, comprises: a requesting step of making a request that an update-information providing apparatus should provide update-information about a program to install and update information about a database schema; a receiving step of receiving the update-information about the program and the update-information about the database schema, both transmitted from the update-information providing apparatus in response to the request; a program-updating step of updating the program in accordance with the update-information about the program; a comparing step of comparing the database schema used by the program with the database schema mounted, in accordance with the update-information about the database schema, in terms of version; and a database schema updating step of updating the database schema mounted, in accordance with the update-information about the database schema, when it is determined in the comparing step that the database schema mounted needs to be updated.

The version of the database schema incorporated is thus determined from the update-information about the database schema. If the database schema needs to be updated in terms of version, it is automatically updated and is of the latest version at all times.

A communication terminal according to this invention is characterized by comprising: a requesting means for making a request that an update-information providing apparatus should provide update-information about a program to install and update information about a database schema; a receiving means of receiving the update-information about the program and the update-information about the database schema, both transmitted from the update-information providing apparatus in response to the request; a program-updating means for updating the program in accordance with the update-information about the program; a comparing means for comparing the database schema used by the program with the database schema mounted, in accordance with the update-information about the database schema, in terms of version; and database schema updating means for updating the database schema mounted, in accordance with the updated-information about the database schema, when the comparing mans determines that the database schema mounted needs to be updated.

The version of the database schema incorporated is thus determined from the update-information about the database schema. If the database schema needs to be updated in terms of version, it is automatically updated and is of the latest version at all times.

A method of providing update-information, according to this invention, is characterized by comprising: a storing step of storing update-information for a program to install in a communication terminal and update-information for a database schema; and a transmitting step of transmitting the update-information for the program and the update-information for the database schema from the communication terminal when the communication terminal requests for the update-information for the program and the update-information for the database scheme. In the method, the program is updated in accordance with the update-information for the program, the database schema used by the program and the database schema mounted are compared in terms of version in accordance with the update-information for the database schema, and the database schema mounted is updated in accordance with the updated-information about the database schema, when it is determined from the result of comparison that the database schema mounted needs to be updated.

The version of the database schema incorporated is thus determined from the update-information about the database schema. If the database schema needs to be updated in terms of version, it is automatically updated in compliance with the program and is of the latest version at all times.

An update-information providing apparatus according to this invention is characterized by comprising: a storing means for storing update-information for a program to install in a communication terminal and update-information for a database schema; and a transmitting means for transmitting the update-information for the program and the update-information for the database schema from the communication terminal when the communication terminal requests for the update-information for the program and the update-information for the database schema. In this apparatus, the program is updated in accordance with the update-information for the program, the database schema used by the program and the database schema mounted are compared in terms of version in accordance with the update-information for the database schema, and the database schema mounted is updated in accordance with the updated-information about the database schema, when it is determined from the result of comparison that the database schema mounted needs to be updated.

The version of the database schema incorporated is thus determined from the update-information about the database schema. If the database schema needs to be updated in terms of version, it is automatically updated and is of the latest version at all times.

A program for updating a database schema, according to this invention, is designed to cause an information-processing apparatus to perform: a requesting step of making a request that an update-information providing apparatus should provide update-information about a program to install and update information about a database schema; a receiving step of receiving the update-information about the program and the update-information about the database schema, both transmitted from the update-information providing apparatus in response to the request; a program-updating step of updating the program in accordance with the update-information about the program; a comparing step of comparing the database schema used by the program with the database schema mounted, in accordance with the update-information about the database schema, in terms of version; and a database schema updating step of updating the database schema mounted, in accordance with the updated-information about the database schema, when it is determined in the comparing step that the database schema mounted needs to be updated.

The version of the database schema incorporated is thus determined from the update-information about the database schema. If the database schema needs to be updated in terms of version, it is automatically updated and is of the latest version at all times.

A program for providing update-information, according to this invention, is designed to cause an information-processing apparatus to perform: a storing step of storing update-information for a program to install in a communication terminal and update-information for a database schema; and a transmitting step of transmitting the update-information for the program and the update-information for the database schema from the communication terminal when the communication terminal requests for the update-information for the program and the update-information for the database schema. The program causes the communication terminal to update the program in accordance with the update-information for the program, to compare the database schema used by the program and the database schema mounted in terms of version in accordance with the update-information for the database schema, and update the database schema mounted in accordance with the updated-information about the database schema, when it is determined from the result of comparison that the database schema mounted needs to be updated.

The version of the database schema incorporated is thus determined from the update-information about the database schema. If the database schema needs to be updated in terms of version, it is automatically updated and is of the latest version at all times.

The present invention can realize a method of updating a database schema, a communication terminal, a method of providing update-information, an update-information providing apparatus, a program for updating a database schema, and a program for providing update-information, in which the version of the database schema incorporated can be determined from the update-information about the database schema. If the database schema needs to be updated in terms of version, it is automatically updated. Hence, the database schema can be of the latest version at all times.

### BRIEF DESCRIPTION OF THE DRAWINGS

FIG. 1 is a schematic diagram showing the overall configuration of an information providing system according to the present invention;

FIG. 2 is a block diagram depicting the configuration of a radio station;

FIG. 3 is a block diagram illustrating the configuration of a related-information providing server;

FIG. 4 is a block diagram illustrating the configuration of an update-information providing server;

FIG. 5 is a block diagram showing the circuit configuration of a client terminal;

FIG. 6 is a diagram explaining how the directory of contents is managed;

FIG. 7 is a diagram showing the program module provided in the client terminal;

FIG. 8 is a diagram illustrating the sequence of acquiring music information representing the musical pieces contained in radio programs;

FIG. 9 is a diagram representing the program configuration of the client terminal;

FIG. 10 is a diagram outlining the process of changing the schema;

FIG. 11 is a flowchart showing the procedure of instructing the changing of a schema;

FIG. 12 is a diagram representing the configuration of a schema-change instruction file;

FIG. 13 is a diagram representing the configuration of a schema-change log file;

FIG. 14 is a diagram illustrating how the schema is updated on the basis of the schema-change instruction file;

FIG. 15 is a diagram outlining the exclusive control process that is performed in the process of changing the schema;

FIG. 16 is a flowchart representing the exclusive control process that is performed in the process of changing the schema; and

FIG. 17 is a flowchart representing the exclusive control process that is performed when an application program is executed.

### BEST MODE FOR CARRYING OUT THE INVENTION

An embodiment of the present invention will be described in detail, with reference to the accompanying drawings.

### (1) Overall Configuration of the Information Providing System

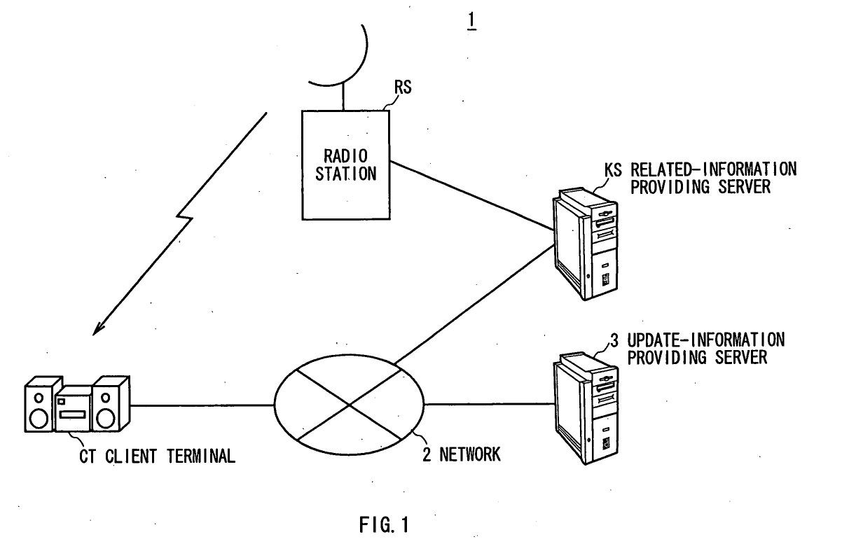

FIG. 1 shows an information providing system 1 according to the present invention. In the system, a client terminal CT receives a broadcast signal from a radio station RS.

In the information providing system 1, a related-information providing server KS composed of a computer and connected to the radio station RS by a dedicated line sets up, for the radio station RS, the homepage of the radio station RS. The related-information providing server KS can therefore supply, as related information, music information about the musical pieces broadcast from the radio station RS through a network 2 in accordance with a request made by the client terminal CT.

The information providing system 1 has an update-information providing server 3, which is connected to the client terminal CT by way of the network 2. The update-information providing server 3 supplies various update information items to the client terminal CT via the network 2, in response to a request made by the client terminal CT.

The client terminal CT updates the program stored in it to the latest version, on the basis of the update information supplied from the update-information providing server 3.

### (1-1) Configuration of the Radio Station RS

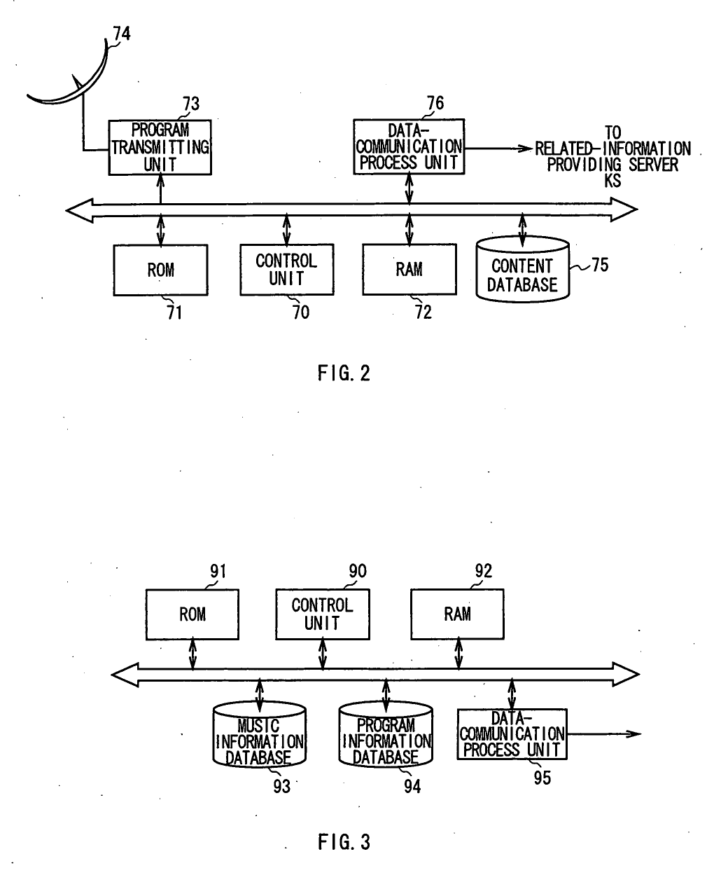

As shown in FIG. 2, in the radio station RS, a control unit 70 comprising a CPU (Central Processing Unit) controls the other components in accordance with the basic program such as OS (Operating System) and various application programs, which have been activated via a ROM (Read Only Memory) 71 and a RAM (Random Access Memory) 72. The radio station RS performs a program broadcasting process, transmitting radio programs from a program transmitting unit 73 through an antenna 74 to the client terminal CT.

The radio station RS has a content database 74 that stores music contents to broadcast in programs and many recorded program contents. The radio station RS broadcasts any of these programs as scheduled in a program table and, if necessary, the music contents in the program being broadcast.

Via a data-communication process unit 76, the radio station RS informs the related-information providing server KS that musical pieces have been broadcast in the program. It also informs the related-information providing server KS that which program is being broadcast at present.

### (1-2) Configuration of the Related-Information Providing Server

As seen from FIG. 3, in the related-information providing server KS, a control unit 90 comprising a CPU controls the other components and performs specific operations, in accordance with the basic program such as OS and various application programs, which have been activated via a ROM 91 and a RAM 92.

The related-information providing server KS retrieves, from a music information database 93, the music information related to the musical pieces that the radio station RS has broadcast in the program. The server KS then supplies the music information, as related information, to the client terminal CT via a data-communication process unit 95.

The related-information providing server KS retrieves, from a program information database 94, the program information related to the program broadcast by the radio station RS, such as the performers' names, the DJ's name, genres and the like, to the client terminal CT via the data-communication process unit 95.

### (1-3) Configuration of the Update-Information Providing Server

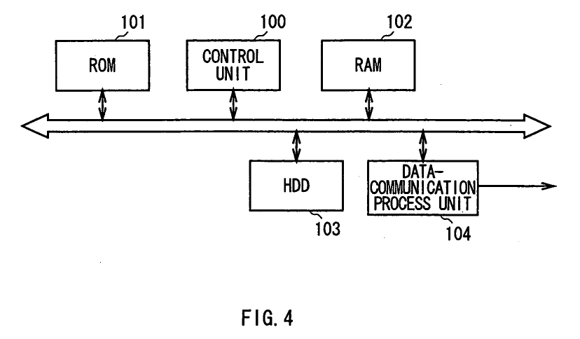

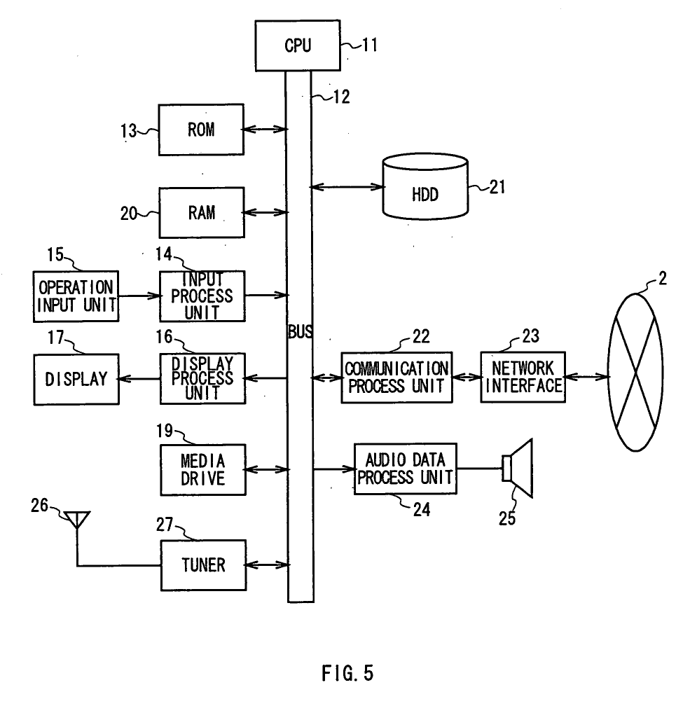

As FIG. 4 shows, in the update-information providing server 3, a control unit 100 comprising a CPU controls the other components and performs specific operations in accordance with the basic program such as OS and update-information providing program, which have been activated via a ROM 101 and a RAM 102.

The update-information providing server 3 selects an update information item from those stored in a hard disk drive 103 in accordance with a request supplied from the client terminal CT. The update information selected accords with the request supplied from the client terminal CT. The update information is supplied to the client terminal CT through a data-communication process unit 104.

### (1-4) Circuit Configuration of the Client Terminal CT

As seen from FIG. 5, in the client terminal CT, a CPU 11 controls the other components and performs specific operations in accordance with the basic program such as OS and various application programs, which have been read from a ROM 13 and developed in a RAM 20. The ROM 13 is connected to the CPU 11 by a bus 12. The CPU 11 performs data communication via, for example, the network 2, receives and supplies data from and to the user, plays back contents from media, writes into a hard disk drive (HDD) 21 the contents downloaded from the radio station RS, and manages these contents in the HDD 21.

An operation input unit 15 sends, to an input process unit 14, the information that the user has input by operating the keys provided on the surface of a main-unit housing or on a remote controller (not sown). The input process unit 14 performs a prescribed process on this information. The information processed is supplied to the CPU 11 as an operation command. The CPU 11 performs a process that accords with the operation command.

A display 17 may be a display device, such as a liquid crystal display, provided directly on the surface of the main-unit housing. Alternatively, it may be an external display device connected to the main-unit housing. The display 17 displays the results of processes performed by the CPU 11 and various information items.

A media drive 19 is a drive that plays back data from, for example, CDs (Compact Discs) or memory sticks (trademark) comprising a flash memory or the like. The data played back is supplied to an audio data process unit 24. The unit 24 performs digital-to-analog conversion on the data, generating analog data. The analog data is supplied to a 2-channel speaker 25, which generates sound from the analog data.

The CPU 11 can store the data played back by the media drive 19, as an audio file, into the hard disk drive 21 if the data is the audio content of a musical piece.

Further, the CPU 11 can cause the media drive 19 to read data representing a plurality of still pictures, from the memory stick, and supply this data to the display 17 via a display process unit 16. Thus, the display 17 can perform a slide show, displaying the still pictures one after another.

Moreover, the CPU 11 can make random access to the hard disk drive 21, thereby to read a plurality of music information items stored in the drive 21. Therefore, the music information items can be read in an order requested by the user as if they were played by a jukebox.

A tuner unit 27 is, for example, an AM radio turner or an FM radio tuner. The tuner unit 27 demodulates the broadcast signal received by the antenna 26, as it is controlled by the CPU 11. The broadcast signal demodulated is supplied, as broadcast audio signal, via an audio data process unit 24 to a speaker 25. The speaker 25 generates broadcast sound from the broadcast audio signal.

A communication process unit 22 encodes the data to transmit, under the control of the CPU 11. The data encoded is transmitted from a network interface 23 via the network 2 to an external apparatus that is compatible with the network 2. The communication process unit 22 decodes data received from the external apparatus via the network interface 23. The data decoded is transferred to the CPU 11.

### (1-5) Directory Management of Contents

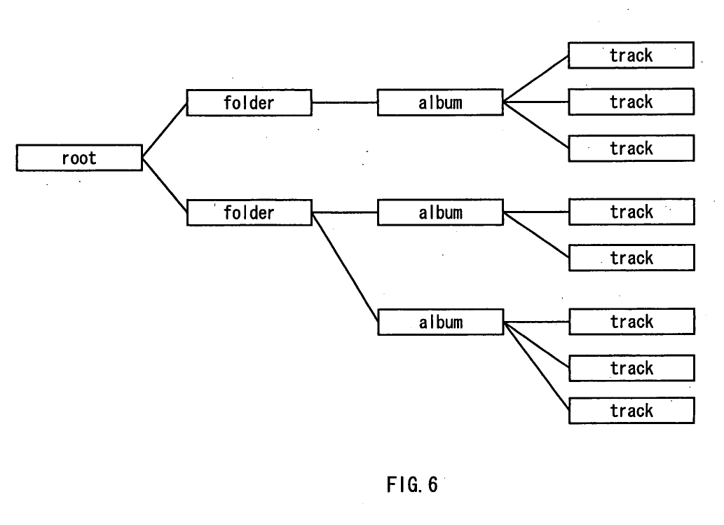

The CPU 11 of the client terminal CT manages the contents stored in the hard disk drive 21, forming the directory configuration illustrated in FIG. 6. First, “folder” directories, i.e., lower layers to the “root” directory, are formed in a given number falling within a prescribed range. The “folder” directories, thus formed, correspond to the various genres of contents or the users owning the contents, respectively.

Then, “album” directories, i.e., lower layers to the “folder” directories, are formed in a given number within a prescribed range. Each “album” directory corresponds to, for example, one album title. At least one “track” file is stored, as lower layer, in each “album” directory. Each “track” file is one musical piece, i.e., content.

The directory management of such contents is carried out in units of database files that are stored in the hard disk drive 21.

### (1-6) Program Module Configuration of the Client Terminal CT

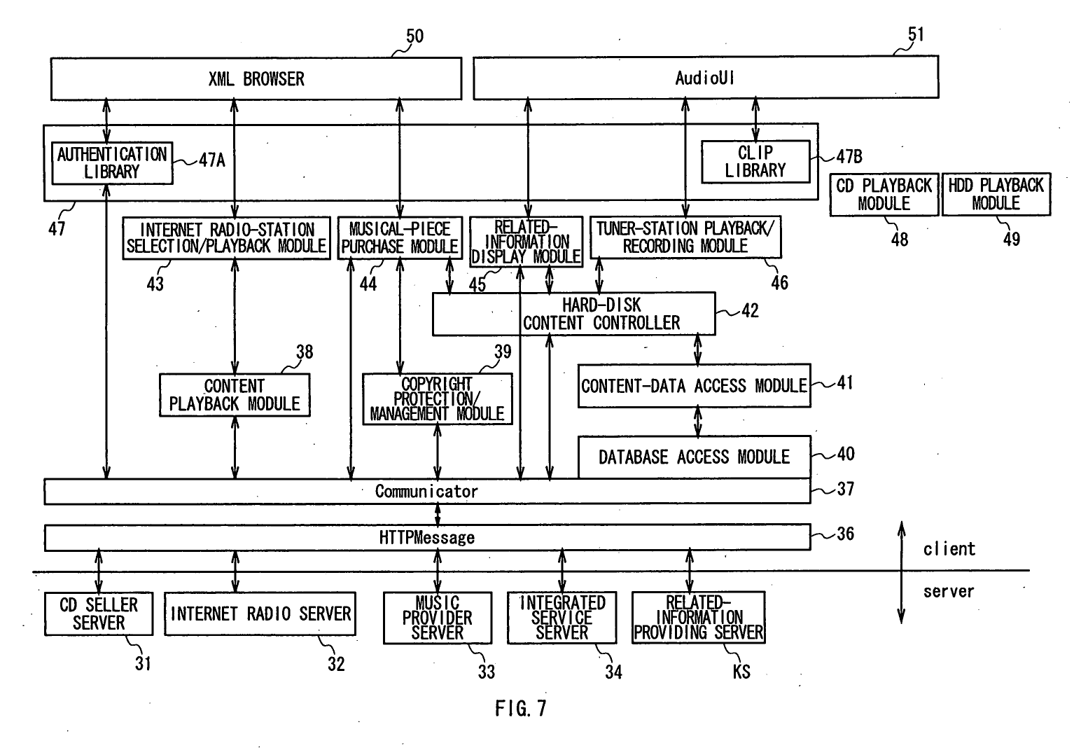

FIG. 7 shows the program module provided in the client terminal CT. As seen from FIG. 7, the program module operates in accordance with the OS. More specifically, the module performs data exchange between a CD seller server 31, an Internet radio server 32, a music provider server 33, an integrated service server 34, the related-information providing server KS, and other various servers. Note that the integrated service server 34 includes the update-information providing server 3 described above.

An HTTP (Hyper Text Transfer Protocol) message program 36 achieves HTTP communication between the CD seller server 31, Internet radio server 32, music provider server 33, integrated service server 34, related-information providing server KS and other various servers. A communicator program 37 is a program module that accomplishes mutual exchange between the HTTP message program 36 and data.

In a layer above the communicator program 37, a content playback module 38 and a copyright protection/management module 39 are provided. The content playback module 38 interprets the codec of any content and plays back the content. The copyright protection/management module 39 handles information concerning copyright. An Internet radio-station selection/playback module 43 is provided to select an Internet radio station and play back any content for the content playback module 38. A musical-piece purchase module 44 is provided to purchase any musical piece and play back the musical piece for advertisement, for the copyright protection/management module 39.

In a layer that lies above the Internet radio-station selection/playback module 43 and musical-piece purchase module 44, an XML (eXtensible Markup Language) browser 50 is provided. The XML browser 50 interprets XML files supplied from various servers and causes the display 17 to display the XML files.

For example, the user may select a musical piece via the XML browser 50. Then, the musical-piece purchase module 44 purchases this musical piece. The musical piece thus purchased is written into the hard disk drive 21 through a hard-disk content controller 42.

The authentication library 47A of a library 47 is connected to the communicator program 37. The authentication library 47A can authenticate the integrated service server 34 and the other servers.

In a layer above the communicator program 37, there are a database access module 40, a content-data access module 41, and a hard-disk content controller 42.

The database access module 40 can access the various databases constructed in the hard disk drive 21. The content-data access module 41 can access the contents stored in the hard disk drive 21. The hard-disk content controller 42 manages the contents stored in the hard disk drive 21.

In a layer above the hard-disk content controller 42, there are a related-information display module 45 and a tuner-station playback/recording module 46. The related-information display module 45 is designed to display the titles of the musical pieces broadcast by the radio station RS and the names of the artists who play these musical pieces. The tuner-station playback/recording module 46 can select the radio station RS and records in the hard disk drive 21 the musical contents it has received from the radio station RS.

A musical piece received from the radio station RS via, for example, an audio user interface 51 is written into the hard disk drive 21 through the content-data access module 41.

The related-information display module 45 receives the titles and artists' names of the musical pieces being broadcast by the radio station RS and being played back by the tuner-station playback/recording module 46, as related information, from the related-information providing server KS via the HTTP message 36. This related information is supplied via the audio user interface (UI) 51 to the display 17. The display 17 displays the related information.

The related information input via the audio user interface 51 and displayed by the display 17 can be temporarily stored in the clip library 47B of the library 47. It can be finally stored into the hard disk drive 21 via the database access module 40 in accordance with an instruction of the user.

The client terminal CT has two program modules, i.e., a CD playback module 48 and an HDD playback module 49. The CD playback module 48 plays back CDs. The HDD playback module 49 plays back the hard disk drive 21. The data played back by these modules 48 and 49 are supplied to the audio data process unit 24 and thence to the speaker 25. The speaker 25 generates sound from the data played back.

### (2) Sequence of Acquiring the Related Information

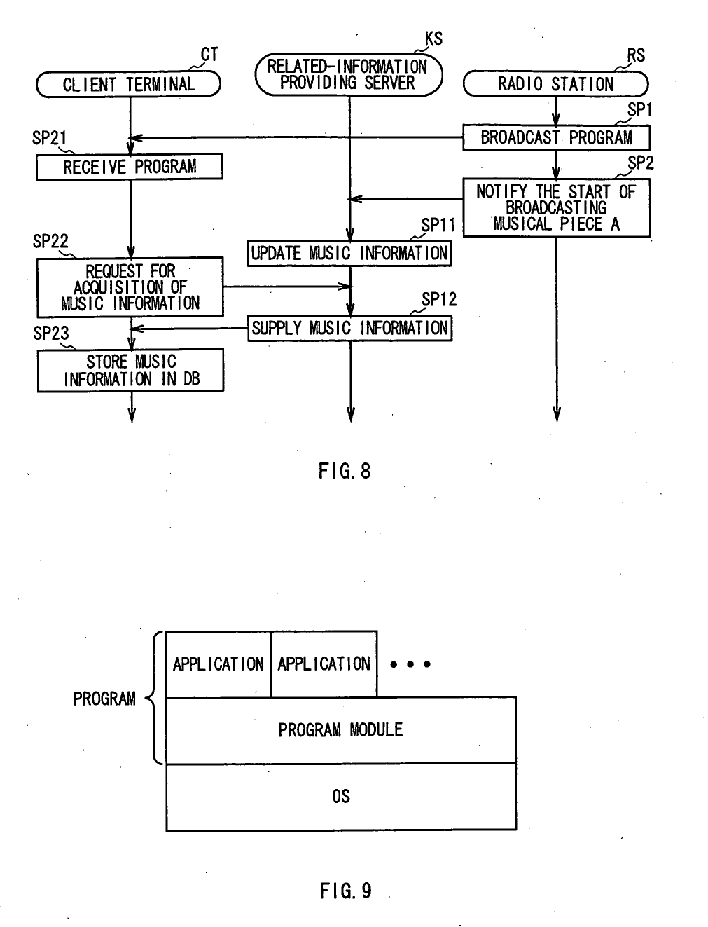

The sequence in which the client terminal CT acquires, from the related-information providing server KS, the related information about the musical pieces contained in a program broadcast by the radio station RS will be explained with reference to FIG. 8.

In Step SP1, the radio station RS starts broadcasting a program. In Step SP2, the station RS starts broadcasting a musical piece A in the program. The station RS informs the related-information providing server KS that it has just started broadcasting the musical piece A.

At this time, or in Step SP11, the related-information providing server KS holds, as a database 93 (FIG. 3), the music information about musical pieces, such as the titles, the names of artists and the image printed on the CD jacket containing the musical pieces. The server KS updates this music information to the music information related to the musical piece A. The music information related to the musical piece A informed of from the radio station RS can therefore be supplied to the client terminal CT. Then, the process goes to Step SP12.

In Step SP21, the client terminal CT receives the program that the radio station RS broadcasts in Step SP1 and the musical piece A broadcast in the program, too. Then, the process goes to Step SP22.

In Step SP22, the client terminal CT transmits a request for the music information about the musical piece A, such as the title and the artist's name, to the related-information providing server KS. The process then goes to Step SP23.

In response to the request from the client terminal CT, the related-information providing server KS supplies, in Step SP12, the music information about the musical piece A, which it holds at present, to the client terminal CT via the network 2.

In the client terminal CT, the display 17 displays, as related information, the music information about the musical piece A, which has been supplied from the related-information providing server KS. The user can therefore recognize the music information about the musical piece A broadcast in the program, such as the title and the artist's name.

In Step SP23, the client terminal CT stores the music information about the musical piece A, supplied from the related-information providing server KS, in the database constructed in the hard disk drive 21. Thus, the client terminal CT can now read any music information as demanded by the user from the database and display the read information on the display 17.

### (3) Schema Changes in the Database

In the information providing system 1, the related-information providing server KS may provide the related information containing additional items when the entire system 1 or part of it is upgraded in terms of version.

Assume that the words and CD number are added to the music information after the system 1 upgraded entirely or in part, while the music information supplied from the related-information providing server KS to the client terminal CT before the system 1 is upgraded entirely or in part contains only the title, artist's name and CD-jacket image.

In this case, the programs and schema of the database must be upgraded in terms of version in the client terminal CT, so that the newly added items may be displayed by the display 17 and registered in the database.

Note that, as shown in FIG. 9, the word “programs” means the various application programs that work on the OS of the client terminal CT and the program module illustrated in FIG. 6. The application programs, which the upper layer, work with the OS via the program module, which is the lower layer. Thus, the display 17 can display desired information, the speaker 25 can generate desired sound and an access can be made to the database constructed in the hard disk drive 21.

Actually, the CPU 11 of the client terminal CT accesses the update-information providing server 3 and determines whether the programs in it are of the latest version. If the programs are not of the latest version, the CPU 11 requests that the update-information providing server 3 should transmit the programs of the latest version to the client terminal CT.

When the update-information providing server 3 is requested that it should transmit the programs of the latest version, it transmits these programs to the client terminal CT. The update-information providing server 3 transmits a schema-change instruction file SF (later described) to the client terminal CT, at the same time it transmits the programs of the latest version. The schema-change instruction file SF changes the database schema of the client terminal CT, making the database schema comply with the programs of the latest version.

When the CPU 11 of the client terminal CT finishes receiving the programs of the latest version and the schema-change instruction file SF, it records the schema-change instruction file SF in the hard disk drive 21. At the same time, the CPU upgrades the programs for itself to those of the latest version.

After upgrading the programs, the CPU 11 starts upgrading the schema of the database to a higher version. The client terminal CT has the function of automatically change (or upgrade in terms of version) the schema of the database in accordance with the schema-change instruction file SF provided from the update-information providing server 3. The schema-changing function will be explained below.

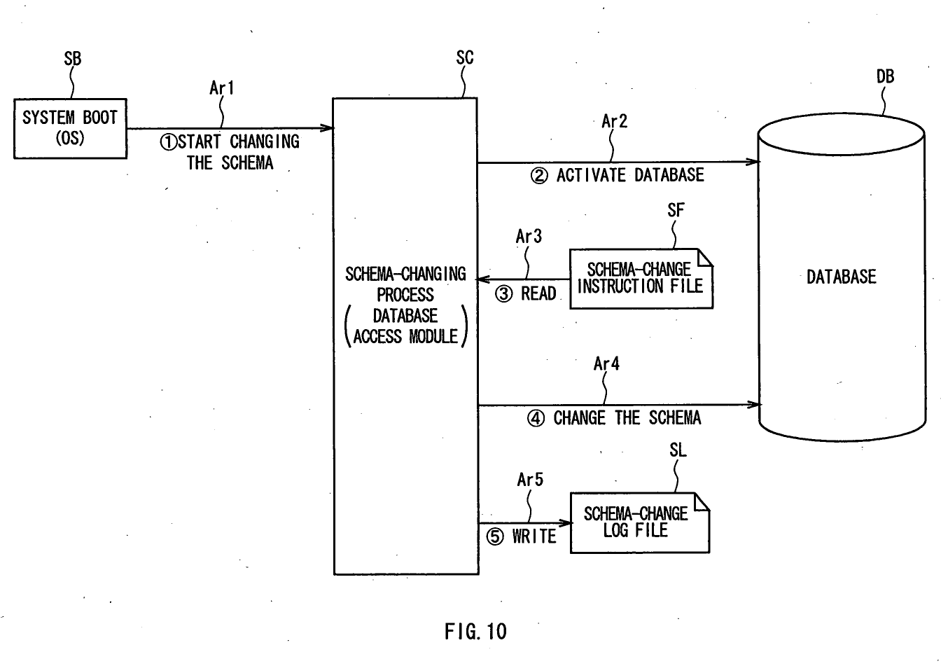

FIG. 10 shows how the schema is changed by using the schema-changing function. After upgrading the programs in terms of version, the CPU 11 of the client terminal CT carries out a system-booting process SB via the OS, booting the entire system of the client terminal CT (hereinafter called terminal system). After carrying out the system-booting process SB, the CPU 11 of the client terminal CT starts the schema-changing process SC via the database access module 40 in Step Ar1. The schema-changing process SC, which will be described in the main in the following description, is carried out by the CPU 11 via the database access module 40 that is one of the program modules.

In the schema-changing process SC, the database DB constructed in the hard disk drive 21 is activated in Step Ar2. The process then goes to Step Ar3.

In Step Ar3, the schema-change instruction file SF supplied from the update-information providing server 3 is read from the hard disk drive 21. The schema-changing process SC goes to Step Ar4.

In Step Ar4, the SQL command, which is described in the schema-change instruction file SF and which will be described later, is issued to the database DB. The schema of the database DB is therefore changed. Then, the schema-changing process SC goes to Step Ar5.

In Step Ar5, the log information about the SQL command issued in Step Ar4 is written into a schema-change log file SL. The schema-changing process SC is then terminated.

The CPU 11 is designed to perform the schema-changing process SC as described above via the database access module 40, after upgrading the programs in terms of version.

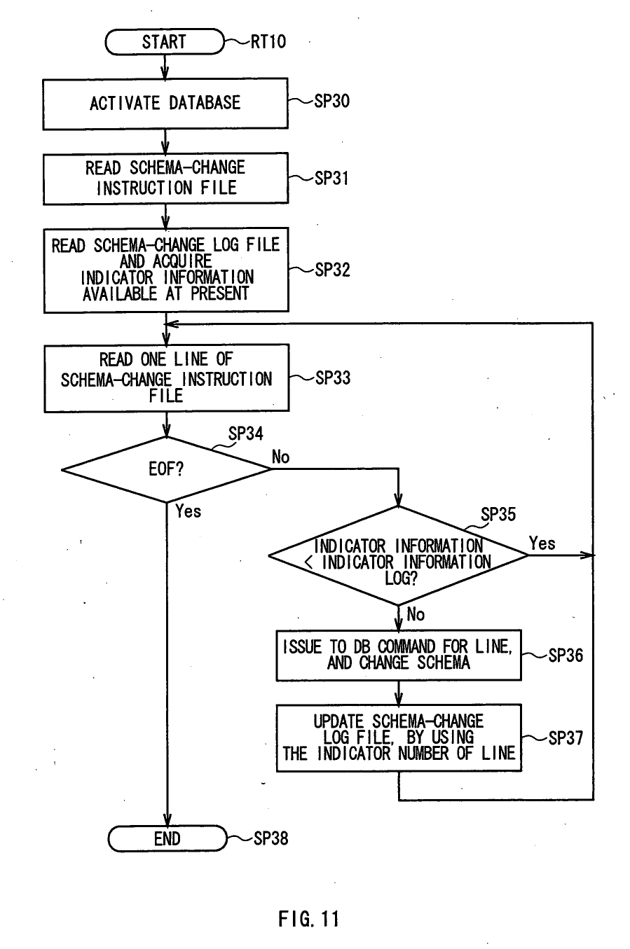

The schema-changing process SC will be described in more detail, with reference to the flowchart shown in FIG. 11. Note that the schema-change sequence RT10 is carried out by the CPU 11 of the client terminal CT via the database access module 40. Steps SP30 to SP37 shown in the flowchart of FIG. 11 correspond to Steps Ar2 to Ar5 illustrated in FIG. 10.

After performing the system-booting process SB, the CPU 11 carries out the schema-change sequence RT10 in accordance with the schema-changing program that has been read from the ROM 13.

On carrying out the schema-change sequence RT10, the CPU 11 activates the database DB in Step SP30. The CPU 11 then goes to Step SP31.

In Step SP31, the CPU 11 reads the schema-change instruction file SF from the hard disk drive 21. The CPU 11 advances to Step SP32.

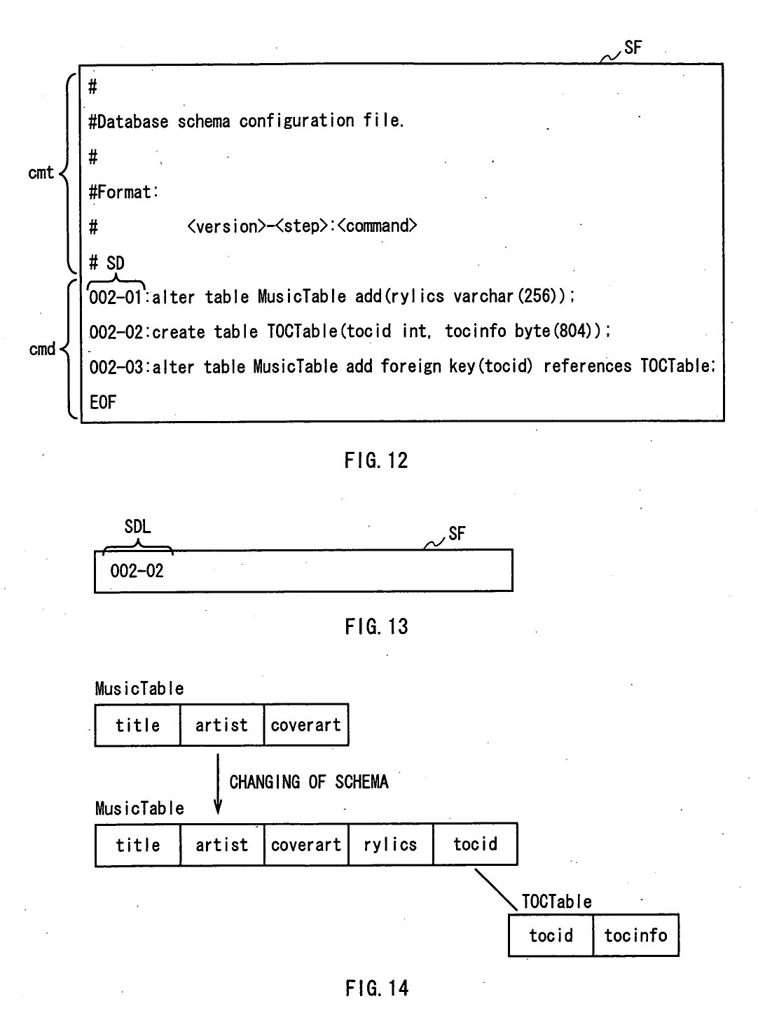

As FIG. 12 shows, the schema-change instruction file SF is a file of text format, consisting of a plurality of lines. The file SF is composed of a comment part cmt and a command parts cmd, In the comment part cmt, each line is headed with “#”. In the command parts cmd, every line, except the last line, is headed with a 3-digit number and a 2-digit number. In the last line of the command parts cmd, only EOF (End Of File) is described. EOF indicates the end position of the schema-change instruction file SF.

In each line of the comment part cmt, a comment sentence about the schema-change instruction file SF is written, following the mark “#”

In every line of the command part cmd (except the last line), mark “:” is added, after the 3-digit and 2-digit numbers, and an SQL command for changing the schema follows the mark “:”. The SQL command is a command described for one line.

Of the numbers SD (hereinafter called indicator information), i.e., 3-digit number and 2-digit number, added at the head of each line of the command part cmd, the 3-digit number represents the version of the schema, and the 2-digit number represents the process number of the schema-change instruction file SF.

If the indicator information SD is “002-02”, the schema is of version “002”, and the schema-change instruction file SF of version “002” has the process number “02”.

In practice, “002-01: alter table MusicTable add (rylics varchar (256);” is described in the first line of the command part cmd of the schema-change instruction file SF shown in FIG. 12. “002-02: create table TOCTable (tocid int, tocinfo byte (804);” is described in the second line of the command part cmd. “002-03: alter table MusicTable add foreign key (tocid) reference TOCTable;” is described in the third line of the command part cmd. And EOF is described in the fourth line of the command part cmd. In this case, the CPU 11 issues three SQL commands described in each line, one by one in the order they are processed.

In Step SP32 (FIG. 11), the CPU 11 reads the schema-change log file which was recorded in the hard disk drive 21 when the programs were upgraded last. The schema-change log file SL is a file of text format, consisting of one line only, as shown in FIG. 13. In this line, a log consisting of a 3-digit number and a 2-digit number is described. (Hereinafter, the log SDL shall be called indicator information log SDL).

The indicator information log SDL corresponds to the indicator information SD of the schema-change instruction file SF. That is, the schema-change log file SL is updated every time the SQL command of each line described in the command part cmd of the schema-change instruction file SF is issued to the database DB. The CPU 11 can therefore determine how far the schema-changing process has proceeded, to which process number of which version, from the indicator information log SDL of the schema-change log file SL.

After reading the schema-change log file SL in Step SP32, thus acquiring the indicator information log SDL of the schema-change log file SL, the CPU 11 goes to the next step, i.e., Step SP33.

In Step SP33, the CPU 11 reads one line of the command part cmd of the schema-change instruction file SF. The CPU 11 then goes to the next step, i.e., Step SP34. In Step SP34, the CPU 11 determines whether EOF is described in the line that has been read. If the decision made here is negative, the line read is not the last line of the schema-change instruction file SF, but is a line that describes an SQL command. In this case, the CPU 11 goes to the next step, i.e., Step SP35.

In Step SP35, the CPU 11 compares the indicator information SD of the line with the indicator information log SDL described in the schema-change log file SL. Thus, the CPU 11 determines whether the indicator information SD is less than the indicator information log SDL.

Assume that the decision made in Step SP35 is affirmative. In this case, the indicator information of the schema-change log file SL is, for example, “002-02” and the indicator information SD of the line read from the schema-change instruction file SF is, for example, “002-01”. This means that the SQL command described in the line has been issued to the database DB. Therefore, the CPU 11 returns to Step SP33 and reads the next line.

The decision made in Step SP35 may be negative. This means that the SQL command described in the line has not been issued. Then, the CPU 11 goes to the next step, i.e., Step SP 36. Namely, the indicator information of the schema-change log file SL is, for example, “002-02” and the indicator information SD of the line read is, for example, “002-03”. In this case, the CPU 11 makes a negative decision in Step SP35 and goes to the next step, i.e., SP36.

In Step SP36, the CPU 11 issues the SQL command described in the line to the database DB. (This SQL command is, for example, “002-03: alter table MusicTable add foreign key (tocid) references TOCTable;”.) The CPU 11 thus changes the schema of the database DB and goes to the next step, i.e., SP37.

In Step SP37, the CPU 11 uses the indicator information SD of the line read (e.g., “002-03”), changing the indicator information log SDL of the schema-change log file SL. Then, the CPU 11 returns to Step SP33 and reads the next line.

Thus, the CPU 11 repeats Steps SP33 to SP37 until EOF is acquired in Step SP34. That is, the CPU 11 issues the SQL commands described in the command part cmd of the schema-change instruction file SF, line by line, changing the schema of the database DB. Then, the CPU 11 goes to the next step, i.e., SP 38, terminating the schema-change sequence RT10.

As a result, the CPU 11 issues the SQL commands described in the schema-change instruction file SF to the database DB in which the schema consists of only the table “MusicTable” composed of three columns “title”, “artist” and “coverart”, thus adding “rylics” and “tocid” to the table “MusicTable”, generating a new table “TOCTable” composed of “tocinfo”. Thus, the database DB can be automatically updated in terms of version to a database having a schema in which the column “tocid” of the table “MusicTable” is linked to the column “tocid” of the table “TOCTable”.

The schema of the database DB is thus automatically updated in terms of version in conformity with the programs, on the basis of the schema-change instruction file SF. Hence, the related information supplied from the related-information providing server KS and having additional items due the version-up of the information providing system 1 can be reflected in the database.

The CPU 11 updates the schema-change log file SL by using the indicator information SD as indicator information log SDL, every time it issues the SQL command described in one line of the schema-change instruction file SF to the database. Therefore, even if the user stops the terminal system while the SQL command in a certain line is being issued or the terminal system is shut down due to power failure, the issuance of the SQL command can be resumed on the basis of the indicator information log SDL of the schema-change log file SL when the schema-changing process SC is carried out again. This can prevent double issuance of the SQL command of the same version.

### (4) Exclusive Control Process

The client terminal CT has an exclusive control function of exclusively controlling the access to the database DB during the schema-changing process SC or during the execution of a specific application. The exclusive control process performed during the schema-changing process and the exclusive control performed during the execution of the specific application will be explained below.

### (4-1) Exclusive Control During the Schema-Changing Process

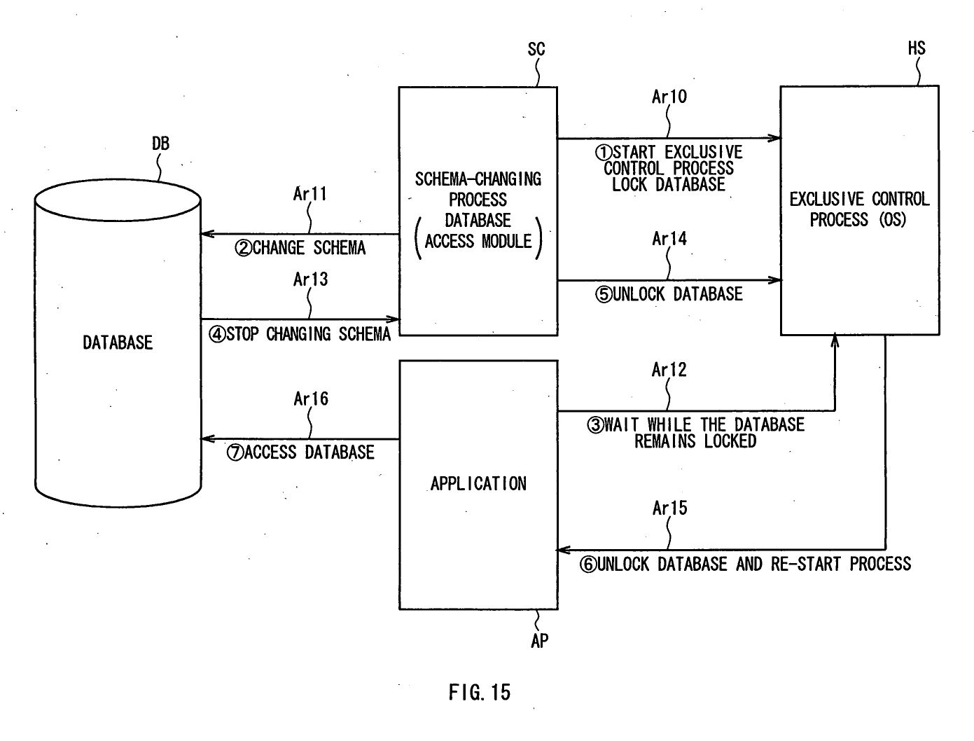

FIG. 15 outlines the exclusive control process that is performed during the schema-changing process. After the schema-changing process SC is started as indicated above, the CPU 11 of the client terminal CT starts the exclusive control process HS via the OS in Step Ar10, locking the database DB. Until the database DB is unlocked, the application AP that executes processes other than the schema-changing process SC cannot access to the database DB. In the following explanation, the application AP and the exclusive control process HS will be described as active entities. In fact, however, the application AP is executed by a program module that is controlled by the CPU 11, and the exclusive control process HS is performed by the CPU 11 via the OS.

After the database DB is locked, the schema-changing process SC proceeds to Step Ar11. In Step Ar11, the schema of the database DB is changed as described above.

At this time, the exclusive control process HS prohibits the application AP from accessing the database DB. Therefore, in Step Ar12, the application AP remains in a waiting state until the database DB is unlocked even if it tries to make access to the database DB.

When the schema of the database DB is completely changed, the schema-changing process SC goes to Step Ar13. In Step Ar13, it is determined that the schema of the database DB has been changed. The process SC then goes to Step Ar14, causing the exclusive control process HS to unlock the database DB.

On unlocking the database DB, the exclusive control process HS makes the application AP start, coming out of the waiting state in Step Ar15. The application AP then goes to Step Ar16, making access to the database DB.

In the client terminal CT, the exclusive control process HS is thus performed so that the application AP may not access the database DB during the schema-changing process SC.

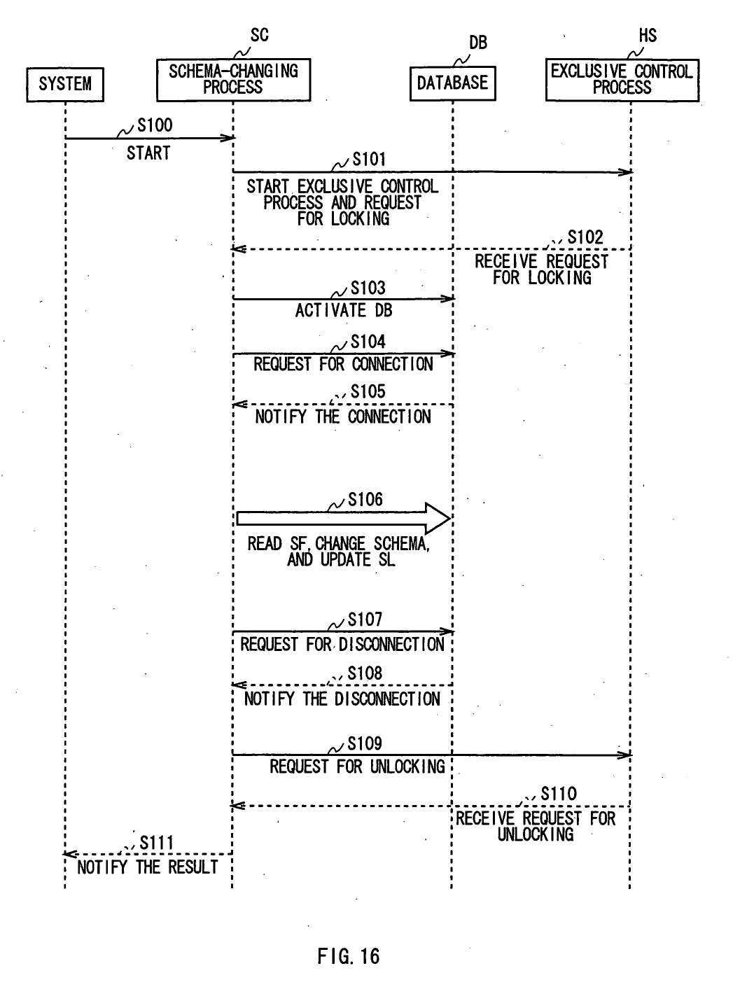

The exclusive control process HS will be described in detail, with reference to the flowchart of FIG. 16. Note that Steps S100 to S110 shown in FIG. 16 correspond to Steps Ar10 to Ar14 that are shown in FIG. 15.

The CPU 11 boots up the system via the OS after it has updated the programs in terms of version. In Step S100, the CPU 11 starts the schema-changing process SC via the database access module 40.

In the schema-changing process SC thus started, the exclusive control process HS is started in Step S101. At the same time, it is requested that the database DB be locked in the exclusive control process HS.

In the exclusive control process HS, the database DB is locked in Step S102 in response to the request made in the schema-changing process SC. A signal showing that the database DB has been locked as requested is sent to the schema-changing process SC.

On recognizing the acceptance of the database locking from the exclusive control process HS, the schema-changing process SC activates the database DB in Step S103. The schema-changing process SC then goes to the next step, i.e., Step S104.

In Step S104, the schema-changing process SC requests that the database DB be connected to the exclusive control process HS.

On recognizing the connection request coming from the schema-changing process SC, the database DB starts the connection to the schema-changing process SC. In Step S105, the database DB then informs the schema-changing process SC that the connection has been initiated.

On recognizing the connection informed by the database DB, the schema-changing process SC goes to Step S106. In Step S106, the schema-changing process SC reads the schema-change instruction file SF and updates the schema of the database DB in accordance with the instruction described in the schema-change instruction file SF. Further, the schema-changing process SC performs the process of changing the schema (FIG. 10 and FIG. 11), updating the schema-change log file SL. The schema-changing process SC goes to the next step, i.e., Step S107.

In Step S107, the schema-changing process SC requests that the database DB be disconnected from it.

On recognizing the request for disconnection, coming from the schema-changing process SC, the database DB disconnects itself from the schema-changing process SC. In Step S108, the database DB informs the schema-changing process SC that it has been disconnected from the process SC.

On recognizing the disconnection of the database DB from it, the schema-changing process SC goes to Step S109. In Step S109, the process SC requests that the exclusive control process HS should unlock the database DB.

On recognizing the unlock request coming from the schema-changing process SC, the exclusive control process HS unlocks the database DB in Step S110. In Step S110, too, the process HS sends a signal showing that the database DB has been unlocked, to the schema-changing process SC.

On recognizing the signal showing that the database DB has been unlocked, coming from the exclusive control process HS, the schema-changing process SC informs the system of the termination of the process SC, in Step S111.

In the client terminal CT, the exclusive control process HS is performed to inhibit any other application AP from accessing the database DB while the schema-changing process SC is being formed. The data stored in the database DB can therefore remain in consistency.

### (4-2) Exclusive Control Process in Application Execution

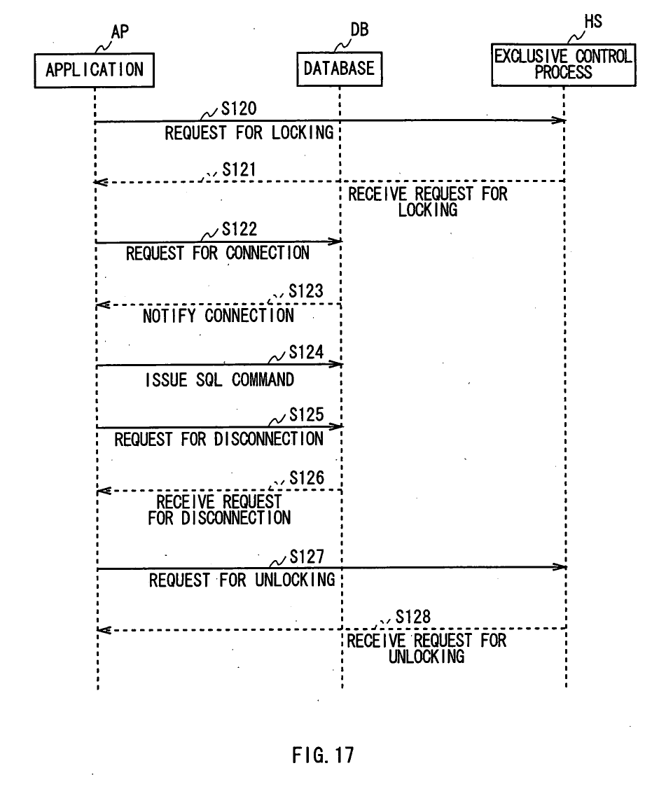

The exclusive control process performed while the application is being executed will be described, with reference to the flowchart of FIG. 17.

If the application AP is executed after the programs and the database DB have been updated in terms of version, it requests in Step S120 that the exclusive control process HS should lock the database DB.

When requested to lock the database DB by the application AP, the exclusive control process HS locks the database DB in Step S121. The process HS then send a signal showing that the lock request has been accepted, to the application AP.

On recognizing the lock acceptance sent from the exclusive control process HS, the application AP requests that the database. DB be connected to it.

On recognizing the connection request coming from the application AP, the database DB starts the connection to the application AP. The database DB then informs the application AP that the connection has been initiated in Step S123.

On recognizing the connection informed by the database DB, the application AP goes to Step S124. In Step S124, the application AP issues a desired SQL command to the database DB. Thus, any desired related information can be stored or read in and from the database DB.

After issuing the desired SQL command, the application AP goes to Step S125. In Step S125, the application AP requests that the database DB be disconnected from it.

On recognizing the request for disconnection, coming from the application AP, the database DB disconnects itself from the application AP. In Step S126, the database DB informs the disconnection to the AP.

On recognizing the disconnection of the database DB from it, the application AP goes to Step S127. In Step S127, the application AP requests that the exclusive control process HS should unlock the database DB.

On recognizing the unlock request coming from the application AP, the exclusive control process HS unlocks the database DB in Step S128. In Step S128, too, the process HS sends a signal showing that the database DB has been unlocked, to the application AP.

In the client terminal CT, the exclusive control process HS is performed to inhibit any other application AP and the schema-changing process SC from simultaneously accessing the database DB while the application AP is accessing the database DB. The data stored in the database DB can therefore remain in consistency. This prevents unauthenticated data from being stored or the data from being erased by error.

### (5) Operation and Advantages

In the configuration described above, the client terminal CT requests that the update-information providing server 3 should send to it the programs of the latest version and the schema-change instruction file SF if the programs in it are not of the latest version.

In response to the request coming from the client terminal CT, the update-information providing server 3 transmits the programs of the latest version and the schema-change instruction file SF to the client terminal CT. After receiving the programs of the latest version and the schema-change instruction file SF, the client terminal CT records the schema-change instruction file SF in the hard disk drive 21 and updates its own programs in terms of version.

After updating the programs, the client terminal CT starts updating the database schema in terms of version. The client terminal CT reads the schema-change instruction file SF. At the same time, the terminal CT reads the schema-change log file SL recorded in the hard disk drive 21 when the database schema was updated in terms of version.

The client terminal CT compares the indicator information SD described in each line of the schema-change instruction file SF with the indicator information log SDL described in the schema-change log file SL updated at the previous version-up. Thus, the client terminal CT issues only the SQL command described in the line that is an indicator information SD greater than the indicator information log SDL, command by command in the order the commands are described in the indicator information DS. At the same time, the terminal CT updates the schema-change log file SL in accordance with the indicator information SD.

In the client terminal CT, the schema-change instruction file SF and the schema-change log file SL are compared, whereby the version of the schema now available is determined. If the schema is not of the latest version, it is automatically updated.

The client terminal CT can therefore automatically update the schema of the database DB so that the schema is always of the latest version.

Thus, all-related information can reliably be reflected in the database DB when the related-information providing server KS provides related information containing more items than before the information providing system 1 was updated in terms of version. Hence, the related information can be reliably prevented from leaking.

In the client terminal CT, the exclusive control process HS is performed, preventing any other application AP from accessing the database DB while the schema-changing process SC is being carried out. The data stored in the database DB can therefore remain in consistency. This prevents unauthenticated data from being stored or the data from being erased by error.

Moreover, in the client terminal CT, the exclusive control process HS is performed, preventing the schema-changing process SC for the database DB from being performed or any other application AP from being executed while the application AP is being executed. The data stored in the database DB can therefore remain in consistency. This prevents unauthenticated data from being stored or the data from being erased by error.

In the configuration described above, the client terminal CT receives the programs of the latest version and the schema-change instruction file SF from the update-information providing server 3, and then compares the indicator information SD of the schema-change instruction file SF with the indicator information log SDL described in the schema-change log file SL, thereby determining the version of the present schema. If the schema is not of the latest version, it is automatically updated to the latest version based on the schema-change instruction file SF. Thus, the database schema, is automatically updated to be of the latest version at all times.

### (6) Other Embodiments

In the embodiment described above, the database DB constructed in the client terminal CT is automatically updated in terms of version. The present invention is not limited to the embodiment. Various communication terminals connected to the update-information providing server 3 via the network 2 and the database DB constructed in the server may be automatically updated in terms of version.

In the embodiment described above, the programs of the latest version are supplied, as latest program information, to the client terminal CT. This invention is not limited to this. Instead, patches or the like for updating the programs may be supplied, as latest program information, to the client terminal CT.

In the above-described embodiment, the schema-change instruction file SF, which is used as latest information, is a file of text format. This invention is not limited to this. The file SF can be of any other format, provided it can be recognized by the client terminal CT.

In the embodiment described above, the schema-change log file SL, which is used as log information about the schema-changing process SC, is a file of text format. The file SL can be of any other format, provided it can be recognized by the client terminal CT.

In this case, a schema-change log table may be generated, in place of, for example, the schema-change log file SL, and the indicator information log SDL may then be written in the schema-change log table.

Further, in the above-described embodiment, the CPU 11 of the client terminal CT develops the in the RAM 20 the schema-changing program stored in ROM 13, and the schema-changing process SC is executed in accordance with the schema-changing program. This invention is not limited to this. A program storage medium storing the schema-changing program may be read into the client terminal CT and thus installed therein, thereby to perform the process of changing the schema.

In the embodiment described above, the control unit 100 of the update-information providing server 3 transmits the programs of the latest version and the schema-change instruction file SF, as latest information, via the network 2 to the client terminal CT that has requested for them, in accordance with the program stored in the ROM 13 and described for providing the updated-information. This invention is not limited to this. A program storage medium storing a communications program may be read into the update-information providing server 3 and thus installed therein, thereby to transmit the programs of the latest version and the schema-change instruction file SF to the client terminal CT.

Further, in the above-described embodiment, the client terminal CT used as a communication terminal comprises the CPU 11 and communication process unit 22 that are used as a requesting means and a receiving means, and the CPU 11 that is used as a program-updating means, a comparing means and a database-schema updating means. The invention is not limited to this. The communication terminal may comprise various circuits of other types.

In the embodiment described above, the update-information providing server 3, which functions as a device for providing the updated-information, comprises the hard disk drive 103 used as a storage means, the control unit 100 used as a means for transmitting to the client terminal CT the program and the schema-change instruction file SF, which are used as program-changing information and latest information about the database schema, respectively, and the data-communication process unit 104 used as a means for transmitting the schema-change instruction file SF to the client terminal CT. The present invention is not limited to this. Other various circuit configurations may constitute a program-providing apparatus.

In the embodiment described above, various processes can be performed by means of the hardware configuration shown in FIGS. 2 to 5. They may be carried out by using software instead. In this case, the programs constituting the software are installed in a general-purpose personal computer or the like that can perform the processes corresponding to the programs, via a network or a recording medium. The personal computer or the like can then perform the various processes.

The recording medium used in this case can be, for example, a magnetic disk (hard disk, floppy disk or the like), magnetic tape, an optical disk (DVD, DVD-RAM, CD-ROM, CD-R (Recordable)/RW (ReWritable), or the like), a magneto-optical disk (MO disk), or a semiconductor memory.

In the embodiment described above, the programs the client terminal CT can receive are those broadcast from radio stations. Nonetheless, the client terminal CT may receive Internet radio programs and satellite radio programs, too, thus acquiring the information related to these programs (radio-broadcast information). Alternatively, the client terminal CT may receive television programs broadcast from television stations and may acquire various broadcast data items about the television programs from a server provided on the network.

In the above-described embodiment, the client terminal CT comprises the various circuits shown in FIG. 5 and the program modules shown in FIG. 7. The present invention is not limited to this, these circuits and modules may be incorporated in various terminals other than the client terminal CT, such as mobile telephones, personal computers, and the like. Any terminal incorporating these circuits and modules can perform the same processes as the client terminal CT described above.

### INDUSTRIAL APPLICABILITY

The present invention can be applied to a communication terminal that has a database.

1. A method of updating a database schema, characterized by comprising:
a requesting step of making a request that an update-information providing apparatus should provide update-information about a program to install and update information about a database schema;
a receiving step of receiving the update-information about the program and the update-information about the database schema, both transmitted from the update-information providing apparatus in response to the request;
a program-updating step of updating the program in accordance with the update-information about the program;
a comparing step of comparing the database schema used by the program with the database schema mounted, in accordance with the update-information about the database schema, in terms of version; and
a database schema updating step of updating the database schema mounted, in accordance with the update-information about the database schema, when it is determined in the comparing step that the database schema mounted needs to be updated.

2. The method of updating a database schema, according to claim 1, characterized in that in the database schema updating step, accesses to the database from the program are inhibited while the database schema is being updated.

3. The method of updating a database schema, according to claim 2, characterized in that in the database schema updating step, accesses to the database from any application in the program is inhibited while the database schema is being updated.

4. The method of updating a database schema, according to claim 1, characterized in that in the database schema updating step, the database schema is inhibited from being updated while the program is accessing the database.

5. The method of updating a database schema, according to claim 4, characterized in that in the database schema updating step, the database schema is inhibited from being updated while any application in the program is accessing the database.

6. The method of updating a database schema, according to claim 1, characterized in that in the database schema updating step, log information is recorded for each command issued to the database to update the database schema.

7. A communication terminal characterized by comprising:
requesting means for making a request that an update-information providing apparatus should provide update-information about a program to install and update information about a database schema;
receiving means of receiving the update-information about the program and the update-information about the database schema, both transmitted from the update-information providing apparatus in response to the request;
program-updating means for updating the program in accordance with the update-information about the program;
comparing means for comparing the database schema used by the program with the database schema mounted, in accordance with the update-information about the database schema, in terms of version; and
database schema updating means for updating the database schema mounted, in accordance with the update-information about the database schema, when the comparing means determines that the database schema mounted needs to be updated.

8. A method of providing update-information, characterized by comprising:
a storing step of storing update-information for a program to install in a communication terminal and update-information for a database schema; and
a transmitting step of transmitting the update-information for the program and the update-information for the database schema from the communication terminal when the communication terminal requests for the update-information for the program and the update-information for the database schema,
wherein the program is updated in accordance with the update-information for the program, the database schema used by the program and the database schema mounted are compared in terms of version in accordance with the update-information for the database schema, and the database schema mounted is updated in accordance with the update-information about the database schema, when it is determined from the result of comparison that the database schema mounted needs to be updated.

9. An update-information providing apparatus characterized by comprising:
storing means for storing update-information for a program to install in a communication terminal and update-information for a database schema; and
transmitting means for transmitting the update-information for the program and the update-information for the database schema from the communication terminal when the communication terminal requests for the update-information for the program and the update-information for the database schema,
wherein the program is updated in accordance with the update-information for the program, the database schema used by the program and the database schema mounted are compared in terms of version in accordance with the update-information for the database schema, and the database schema mounted is updated in accordance with the update-information about the database schema, when it is determined from the result of comparison that the database schema mounted needs to be updated.

10. A program for updating a database schema, designed to cause an information-processing apparatus to perform:
a requesting step of making a request that an update-information providing apparatus should provide update-information about a program to install and update information about a database schema;
a receiving step of receiving the update-information about the program and the update-information about the database schema, both transmitted from the update-information providing apparatus in response to the request;
a program-updating step of updating the program in accordance with the update-information about the program;
a comparing step of comparing the database schema used by the program with the database schema mounted, in accordance with the update-information about the database schema, in terms of version; and
a database schema updating step of updating the database schema mounted, in accordance with the updated-information about the database schema, when it is determined in the comparing step that the database schema mounted needs to be updated.

11. A program for providing update-information, designed to cause an information-processing apparatus to perform:
a storing step of storing update-information for a program to install in a communication terminal and update-information for a database schema; and
a transmitting step of transmitting the update-information for the program and the update-information for the database schema from the communication terminal when the communication terminal requests for the update-information for the program and the update-information for the database schema,
said program causing the communication terminal to update the program in accordance with the update-information for the program, to compare the database schema used by the program and the database schema mounted in terms of version in accordance with the update-information for the database schema, and update the database schema mounted in accordance with the updated-information about the database schema, when it is determined from the result of comparison that the database schema mounted needs to be updated.
